(19) United States
(12) Patent Application Publication
(10) Pub. No.: US 2005/0130637 A1
(43) Pub. Date: Jun. 16, 2005

(54) Method for transmitting service data using a discontinuous transmission mode

(76) Inventor: Tung-Feng Yang, Taipei City (TW)

Correspondence Address: RABIN & Berdo, PC, 1101 14TH STREET, NW, SUITE 500, WASHINGTON, DC, 20005, US

(21) Appl. No.: 11/008,216

(22) Filed: Dec. 10, 2004

(30) Foreign Application Priority Data
Dec. 12, 2003 (TW) 92135289

(51) Int. Cl. H04Q 7/20

(52) U.S. Cl. 455/414.2; 455/414.3

(57) ABSTRACT

A method of transmission service data using a discontinuous transfer mode. When the local mobile phone wishes to download the service data from the network, the network combines the service data with a silence descriptor frame, which is transmitted from the remote mobile phone, into combined data after the remote mobile phone is in the discontinuous transmission mode, and transmits the combined data to the local mobile phone. The local mobile phone creates background noise according to the silence descriptor frame in order to provide the user a continuous sound effect. When the local mobile phone wishes to output the service data, it combines the silence descriptor frame with the service data into the combined data and outputs the combined data after it enters the discontinuous transmission mode. The network or remote mobile phone can create the background noises to provide the user the continuous sound effect.

This application claims the benefit of Taiwan application Serial No. 92135289, filed Dec. 12, 2003, the subject matter of which is incorporated herein by reference.

### BACKGROUND OF THE INVENTION

1. Field of the Invention

The invention relates in general to a data transmission method, and more particularly to a method for transmitting service data using a discontinuous transmission mode.

2. Description of the Related Art

With the high development of the electrical industry, the alternation of generation of the mobile communication technology is very fast. Taking the mobile telephone (or mobile phone) as an example, except for the fundamental communicating function, the provider has provided the services such as audio mailbox and short message transmission in order to integrate more and more functions in the mobile phone.

The service providers of the mobile communication systems can provide various services, which include the most fundamental short message service (SMS), the image and voice transmission, or the e-mail access using the WAP (Wireless Application Protocol). The precondition for the data transmission and acquisition is that the system service provider has had the service providing ability (e.g., message transmission). The user has to request the provider to provide the value-added service (e.g., Multimedia Messaging Services, MMS) with larger data quantity, and the traffic channel bandwidth has to be additionally occupied during the usage, which must be paid for.

In general, SMS is transmitted through the control channel. However, when the data quantity is larger, this method cannot be utilized to transmit. Instead, a specific data transmission connection line has to be additionally built, so the traffic channel bandwidth is occupied. According to the current trend, the data quantity transmitted by the user is getting larger and larger and the usage chance is getting higher and higher. For example, the photo transmission, music or even the short film share occupies a relatively large bandwidth. Because the bandwidth is restricted, when the system loading is increased, the bandwidth usage increases and thus makes the network busy.

In order to solve this problem, the traffic channel bandwidth has to be used in a more efficient way so that the data is transmitted without increasing the bandwidth usage.

### SUMMARY OF THE INVENTION

It is therefore an object of the invention to provide a method for transmitting service data using a discontinuous transmission mode so as to efficiently use the bandwidth and reduce the communication cost.

The invention achieves the above-identified object by providing a data transmission method for transmitting service data using a discontinuous transmission mode. The method includes the steps to be described in the following.

When the local mobile phone communicates with the remote mobile phone, the service data may be downloaded or uploaded between the local mobile phone and the network. The service data also may be transmitted to the remote mobile phone through the network. When the local mobile phone wishes to download the service data from the network, the network combines the service data with the silence descriptor frame (SID frame) transmitted from the remote mobile phone, and then transmits the combined data to the local mobile phone after the remote mobile phone had entered the discontinuous transmission mode (DTX mode). Thereafter, the local mobile phone parses the combined data into the service data and the silence descriptor frame and may thus save the service data, and create background noise in order to provide the user the continuous sound effect according to the silence descriptor frame.

When the local mobile phone wishes to transmission the service data to the remote mobile phone, it can first inform the remote mobile phone to prepare to receive data. After the local mobile phone has entered the DTX mode, the silence descriptor frame and the service data are combined into the combined data and then transmitted to the remote mobile phone. After receiving the combined data, the remote mobile phone parses it into the service data and the silence descriptor frame, and creates the background noise and simultaneously stores the service data into the memory according to the content of the silence descriptor frame. When the local mobile phone leaves the DTX mode, the outputting of the service data is stopped, and the data transmission will be recovered after the DTX mode is entered at the next time.

When the local mobile phone wishes to upload the service data to the network, it can combine the silence descriptor frame with the service data into the combined data after it has entered the DTX mode, and then transmit the combined data to the network. After receiving the combined data, the network parses the combined data into the service data and the silence descriptor frame. The service data may be saved into the database in the network, and the silence descriptor frame data is transmitted to the remote mobile phone in order to provide the remote user the continuous sound effect. After the service data transmission is completed, the local mobile phone informs the network to stop receiving data, and the network also informs the local mobile phone that the service data transmission is completed.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows the frame usage in the discontinuous transmission mode.

FIG. 2 shows the condition when the mobile telephones are communicating with each other.

FIG. 3 shows a service data transmission method according to a first embodiment of the invention.

FIG. 4 shows a service data transmission method according to a second embodiment of the invention.

FIG. 5 shows a service data transmission method according to a third embodiment of the invention.

### DETAILED DESCRIPTION OF THE INVENTION

When two devices are communicating with each other, the idea of the invention is to transmit data according to an idle frame when one of the devices is in the discontinuous transmission mode (DTX mode). The so-called discontinuous transmission mode may be roughly understood as “the data transmission mode when no voice is outputted”. That is, the voice is not continuous when a person is talking because he or she has to stop to listen to the other person, and he or she may rest during the talking. At this time, the system detects that the user does not output the voice, and enables the discontinuous transmission mode. FIG. 1 shows the frame usage in the discontinuous transmission mode. In a device entering the DTX mode, many traffic channels (TCHs), such as the idle frame 101, are released, and in those free traffic channels don't include voice data. However, one silence descriptor frame (SID frame) 110 is sent to the other device every period of time in order to simulate the background noise of the environment. The user of the other device can identify that the communication is ongoing according to the voice of the background noise.

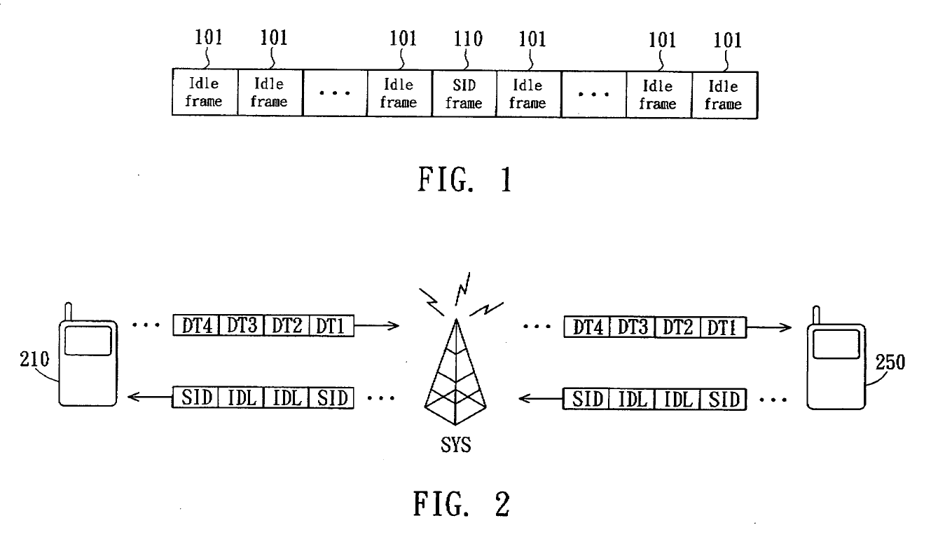

FIG. 2 shows the condition when the mobile telephones are communicating with each other. As shown in FIG. 2, the first device (local mobile phone 210) communicates with the second device (remote mobile phone 250) through the network SYS, and the second device receives the signals from the first device. When the user of the first device is speaking, the first device will transmit the frames of the voice data DT1, DT2, DT3 and DT4 to the second device sequentially. Assume that the user of the second device does not speak and thus the second device is in the discontinuous transmission mode, so it sends a lot of idle frames IDL and the silence descriptor frame SID. When the network SYS receives the silence descriptor frame SID, it transmits the silence descriptor frame SID to the first device. After the first device receives the silence descriptor frame SID, the SID is processed by the signal processing procedure such as decoding, and then the first device can continuously output the background noise.

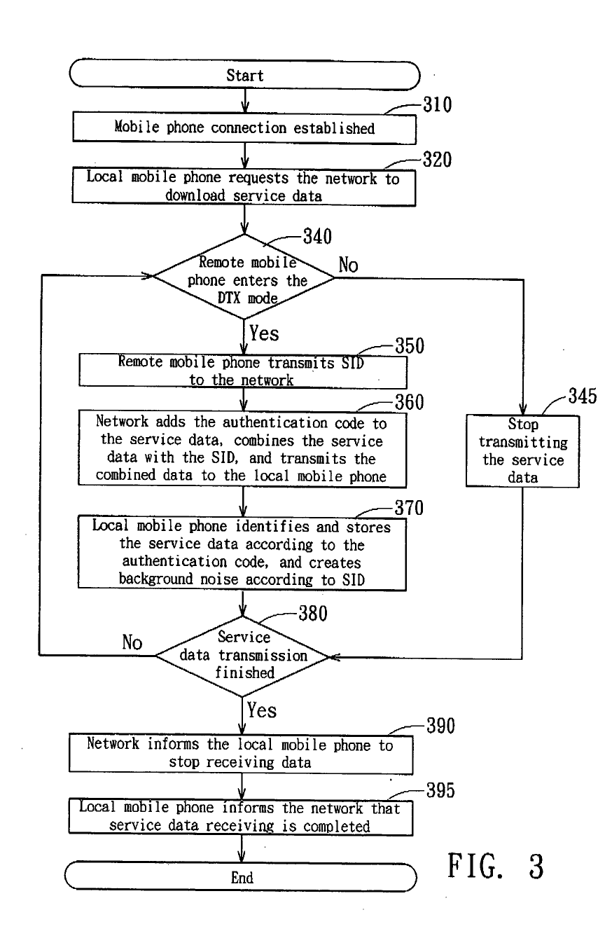

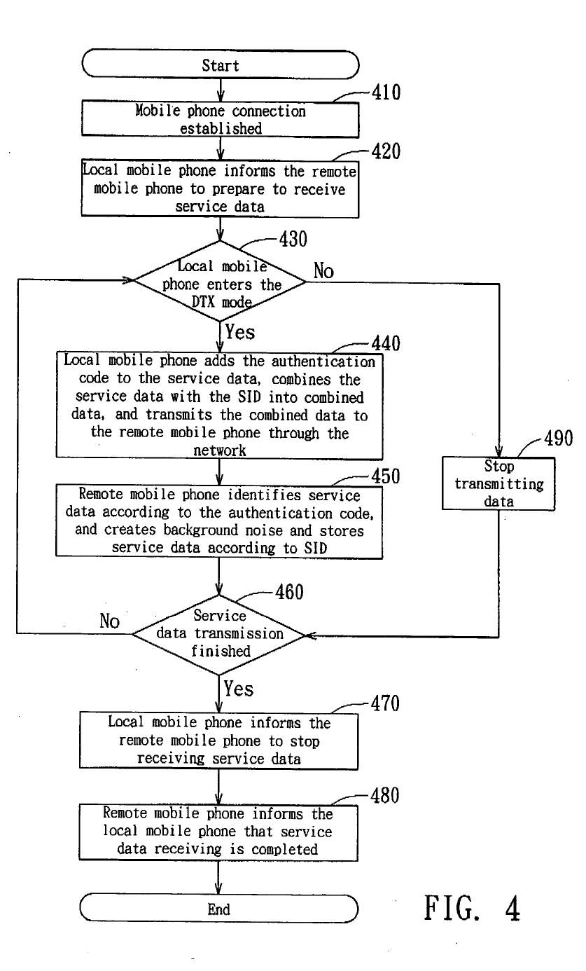

FIG. 3 shows a service data transmission method according to a first embodiment of the invention. As shown in FIG. 3, the local mobile phone can download and store the service data from the network SYS when it is communicating with the remote mobile phone. The local mobile phone is, for example, the mobile telephone 210 of FIG. 2, and the remote mobile phone is, for example, the mobile telephone 250 of FIG. 2. After the first device (local mobile phone 210) connecting with the second device (remote mobile phone 250) (step 310), the first device requests the network SYS to download the service data (step 320). After the second device enters the DTX mode (step 340, the judgement is Yes), the first device is informed to receive the service data.

After the second device (remote mobile phone 250) enters the DTX mode, the second device transmits the silence descriptor frame SID to the network SYS (step 350). After receiving the silence descriptor frame SID, the network SYS adds the authentication code to the service data and combines the SID with the service data into combined data to be transmitted to the first device (local mobile phone 210), and the first device receives the combined data (step 360). It is to be noted that the service data still can be distinguished from the silence descriptor frame SID after the data is combined because the network SYS has added the authentication code to the service data.

After receiving the combined data, the first device (local mobile phone 210) parses it into the service data and the silence descriptor frame SID and respectively process the service data and the silence descriptor frame SID. The first device creates the background noise according to the silence descriptor frame SID, and the background noise is to be played from the speaker in order to provide the user the continuous sound effect. On the other hand, the first device stores the service data into the memory (step 370), and repeats steps 340 to 370 until the data receiving is finished (step 380, the judgement is No). On the contrary, if the service data transmission has finished (step 380, the judgement is Yes), the network SYS informs the first device to stop receiving data (step 390), and the first device also informs the network SYS that the service data receiving is completed (step 395). It is to be noted that when the second device (remote mobile phone 250) leaves the DTX mode (step 340, the judgement is No), the network stops the transmission of the service data (step 345), and the data transmission will not be recovered until the second device again enters the DTX mode.

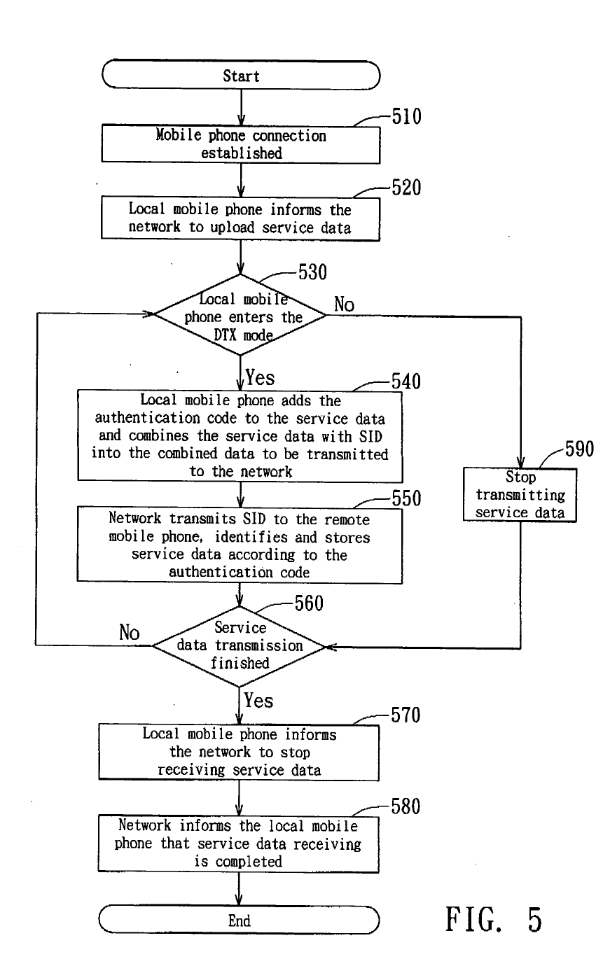

FIG. 4 shows a service data transmission method according to a second embodiment of the invention. As shown in FIG. 4, the first device (local mobile phone 210) can transmit the service data to the second device when the first device is communicating with the second device (remote mobile phone 250). After the first device connecting with the second device (step 410), the first device informs the second device to prepare to receive data (step 420). After the first device enters the DTX mode (step 430, the judgement is Yes), the first device adds the authentication code to the service data, and combines the silence descriptor frame SID with the service data into the combined data, which is to be transmitted to the second device through the network SYS, and the second device receives the combined data (step 440). After receiving the combined data, the second device parses it into the service data and the silence descriptor frame SID according to the authentication code, and plays the background noise according to the silence descriptor frame SID. Meanwhile, the second device stores the service data to the memory (step 450). Steps 430 to 450 are repeated until the data receiving is finished (step 460, the judgement is No). On the contrary, if the service data transmission has finished (step 460, the judgement is Yes), the first device informs the second device to stop receiving data (step 470), and the second device also informs the first device that the service data receiving is completed (step 480). When the first device leaves the DTX mode (step 430, the judgement is No), the output of the service data is stopped (step 490), and the data transmission is recovered after the first device enters the DTX mode again.

FIG. 5 shows a service data transmission method according to a third embodiment of the invention. As shown in FIG. 5, the first device can upload the service data to the network SYS when the first device is communicating with the second device. Then, the first device can further request the network SYS to transmit the service data to a third device that is not communicating with the first device. After the first and the second devices communicate with each other (step 510), the first device requests the network SYS to upload the service data (step 520). After the first device enters the DTX mode (step 530, the judgement is Yes), the first device adds the authentication code to the service data, and combines the silence descriptor frame SID with the service data into the combined data, and then transmits the combined data to the network SYS (step 540). After receiving the combined data, the network SYS parses the combined data into the service data and the silence descriptor frame SID according to the authentication code. At this time, the service data is stored into the database in the network, and the network SYS transmits the silence descriptor frame SID to the second device in order to provide the user of the second device a continuous sound effect (step 550). Steps 530 to 550 are repeated until the network SYS has finished receiving the data (step 560, the judgement is No). On the contrary, if the service data transmission has finished (step 560, the judgement is Yes), the first device informs the network SYS to stop receiving data (step 570), and the network SYS also informs the first device that the service data receiving is completed (step 580). If the first device requests the network SYS to transmit the service data to the third device, which is not communicating with the first device, the network SYS will transmit the service data to the third device. At this time, the data transmission method in the network SYS and the third device may be the typical prior art data transmission method or the data transmission method of the invention. It is to be noted that when the first device leaves the DTX mode (step 530, the judgement is No), it will stop the service data transmission (step 590), and the data transmission will be recovered when the first device enters the DTX mode again.

The data transmission methods for transmitting the service data using the discontinuous transmission DTX mode according to the embodiments of the invention have the following advantages.

1. No additional link has to be created in order to transmit the service data, so the service provided by the system provider may be enjoyed during the typical communication procedure, and no additional connection cost will be paid for.

2. The data access speed is increased using the higher bandwidth released in the DTX to request the system end for the data service.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A data transmission method for transmitting service data using a discontinuous transmission (DTX) mode, the method being applied when a local mobile phone communicates with a remote mobile phone through a network, in which the service data is stored for the local mobile phone to download, the method comprising the steps of:
enabling the local mobile phone to request to download the service data from the network;
transmitting a silence descriptor frame (SID frame) to the network when the remote mobile phone being in the discontinuous transmission mode;
enabling the network to combine the service data with the silence descriptor frame into combined data, and transmitting the combined data to the local mobile phone;
enabling the local mobile phone to parse the combined data into the service data and the silence descriptor frame; and
informing the network that the service data transmission is completed when finishing receiving the service data.

2. The method according to claim 1, wherein the remote mobile phone enters the discontinuous transmitting mode when stopping transmitting voice data during connection with the local mobile phone.

3. The method according to claim 1, wherein the network further adds an authentication code to the service data, and the local mobile phone parses the combined data according to the authentication code, so that the service data and the silence descriptor frame are processed respectively.

4. The method according to claim 1, wherein when the remote mobile phone is in the discontinuous transmission mode, the local mobile phone creates a background noise according to the silence descriptor frame, and the local mobile phone plays the background noise in order to provide a continuous sound effect for a user of the local mobile phone.

5. The method according to claim 1, wherein the service data is one of an image, music, a picture and an e-mail.

6. The method according to claim 1, wherein the service data is a kind of multimedia message services (MMS).

7. A data transmission method for transmitting service data using a discontinuous transmission (DTX) mode, the method being applied when a local mobile phone communicates with a remote mobile phone through a network, the service data being stored in the local mobile phone and to be uploaded to the network, the method comprising the steps of:
enabling the local mobile phone to request to upload the service data from the network;
combining the service data with a silence descriptor frame into combined data when the local mobile phone is in the discontinuous transmission mode, and transmitting the combined data to the network;
enabling the network to parse the combined data into the service data and the silence descriptor frame, wherein the network stores the service data and transmits the silence descriptor frame to the remote mobile phone; and
informing the local mobile phone that the service data transmission is completed when the network finishes receiving the service data.

8. The method according to claim 7, wherein the remote mobile phone enters the discontinuous transmitting mode when stopping transmitting voice data during connection with the local mobile phone.

9. The method according to claim 7, wherein the local mobile phone further adds an authentication code to the service data, and the network parses the combined data according to the authentication code so that the service data and the silence descriptor frame are processed, respectively.

10. The method according to claim 7, wherein when the local mobile phone is in the discontinuous transmission mode, the remote mobile phone creates a background noise according to the silence descriptor frame, and the remote mobile phone plays the background noise in order to provide a continuous sound effect for a user using the remote mobile phone.

11. The method according to claim 7, wherein the service data is one of an image, music, a picture and an e-mail.

12. The method according to claim 7, wherein the service data is a kind of a multimedia message services (MMS).

13. A data transmission method for transmitting service data using a discontinuous transmission (DTX) mode, the method being applied when a local mobile phone communicates with a remote mobile phone through a network, the service data is stored in the local mobile phone and to be transmitted to the remote mobile phone, the method comprising the steps of:
enabling the local mobile phone to request to transmit the service data to the remote mobile phone;
combining the service data with a silence descriptor frame into combined data when the local mobile phone is in the discontinuous transmission mode, and transmitting the combined data to the remote mobile phone after the remote mobile phone starts receiving data;
enabling the remote mobile phone to parse the combined data into the service data and the silence descriptor frame; and
informing the local mobile phone that the service data transmission is completed when the remote mobile phone finishes receiving the service data.

14. The method according to claim 13, wherein the remote mobile phone enters the discontinuous transmitting mode when stopping transmitting voice data during connection with the local mobile phone.

15. The method according to claim 13, wherein the local mobile phone further adds an authentication code to the service data, and the remote mobile phone parses the combined data according to the authentication code so that the service data and the silence descriptor frame are processed, respectively.

16. The method according to claim 13, wherein when the local mobile phone is in the discontinuous transmission mode, the remote mobile phone creates a background noise according to the silence descriptor frame, and the remote mobile phone plays the background noise in order to provide a continuous sound effect for a user using the remote mobile phone.

17. The method according to claim 13, wherein the service data is one of an image, music, a picture and an e-mail.

18. The method according to claim 13, wherein the service data is a kind of a multimedia message services (MMS).

19. A data transmission method being applied when a local mobile phone communicates with a remote mobile phone through a network, the remote mobile phone being in a discontinuous transmission mode, the remote mobile phone transmitting a silence descriptor frame to the network when a user using the remote mobile phone does not talk, the network storing service data and combining the service data with the silence descriptor frame into combined data, the method comprising the steps of:
enabling the local mobile phone to request to download the service data from the network;
enabling the local mobile phone to receive the combined data transmitted from the network;
enabling the local mobile phone to parse the combined data into the service data and the silence descriptor frame; and
informing the network that the service data transmission is completed when the local mobile phone finishes receiving the service data.

20. The method according to claim 19, wherein the local mobile phone creates a background noise according to the silence descriptor frame, the local mobile phone plays the background noise in order to provide a continuous sound effect for a user using the local mobile phone.
